(19) United States
(12) Patent Application Publication
(10) Pub. No.: US 2024/0330050 A1
(43) Pub. Date: Oct. 3, 2024

(54) METHOD AND APPARATUS TO ALLOW ADJUSTMENT OF THE CORE AVAILABILITY MASK PROVIDED TO SYSTEM SOFTWARE

(71) Applicant: Intel Corporation, Santa Clara, CA (US)

(72) Inventors: Madhusudan Chidambaram, Bangalore (IN); Efraim Rotem, Haifa (IL); Stephen H. Gunther, Beaverton, OR (US); Rajshree Chabukswar, Sunnyvale, CA (US); Zhongsheng Wang, Camas, WA (US)

(21) Appl. No.: 18/193,127

(22) Filed: Mar. 30, 2023

(51) Int. Cl. G06F 9/48; G06F 9/50

(52) U.S. Cl. CPC G06F 9/4893; G06F 9/5094

(57) ABSTRACT

Embodiments herein relate to selecting cores in a processor using a core mask. In one aspect, a computing device includes different types of cores arranged in one or more processors. The core types are different in terms of performance and power consumption. A core mask is provided which indicates the number of cores which are selected to be active for each core type. A driver can receive a gear setting, which represents a first preference for higher performance or reduced power consumption. A slider value, which represents a second preference for higher performance or reduced power consumption, is provided based on the gear setting and a core utilization percentage and/or foreground activity percentage. A core mask is selected based on the slider value and the current workload type. The first preference can guide, without dictating, a decision of which cores are selected.

### FIELD

The present application generally relates to the field of computing devices and more particularly to scheduling work on processor cores.

### BACKGROUND

Multicore processors have become increasingly popular in computing devices. They offer a number of advantages, including increased performance, improved multitasking, reduced power consumption and faster response times. However, various challenges are presented in scheduling work on the processor cores.

### BRIEF DESCRIPTION OF THE DRAWINGS

The embodiments of the disclosure will be understood more fully from the detailed description given below and from the accompanying drawings of various embodiments of the disclosure, which, however, should not be taken to limit the disclosure to the specific embodiments, but are for explanation and understanding only.

FIG. 1A depicts an example dynamic core configuration in a computing device, according to various embodiments.

FIG. 1B depicts an example implementation of the Enhanced Hardware Feedback Interface (EHFI) table 131 of FIG. 1A, according to various embodiments.

FIG. 2 depicts a high-level overview of a system in which a Dynamic Tuning Technology (DTT) driver 220, corresponding to the DTT driver 120 of FIG. 1A, implements Energy Performance Preferences (EPPs) in a computing device, according to various embodiments.

FIG. 3A depicts a high-level overview of a system in which a DTT driver 320, corresponding to the DTT driver 120 of FIG. 1A, implements EPPs and OEM preferences in a computing device, according to various embodiments.

FIG. 3B depicts example plots of slider value versus a core utilization percentage and/or a foreground activity percentage (FG %), for the different gear setting in FIG. 3A, according to various embodiments.

FIG. 4 depicts an example table of core mask configurations cross-referenced to five sliders and five workload types, in a 2-8-2 configuration, consistent with the three core types of FIG. 1A, according to various embodiments.

FIG. 5 depicts additional components in the dynamic core configuration of FIG. 1A, to provide a system which selects processor cores based on both EPPs and sliders, according to various embodiments.

FIG. 6 depicts an example table of core mask configurations cross-referenced to three sliders and five workload types, in a 4-8-2 configuration, consistent with the three core types of FIG. 1A, according to various embodiments.

FIG. 7 depicts an example table of core mask configurations cross-referenced to three sliders and five workload types, in a 12-8-2 configuration, consistent with the three core types of FIG. 1A, according to various embodiments.

FIG. 8 depicts an example implementation of a system for updating the Enhanced Hardware Feedback Interface (EHFI) table 131 of FIG. 1A based on EPPs and sliders, consistent with the table of FIG. 4, according to various embodiments.

FIG. 9 depicts an example implementation of the set of multi-core processors Proc1, Proc2 and Proc3 of FIG. 1A, according to various embodiments.

FIG. 10 illustrates an example of components that may be present in a computing system 1250 for implementing the techniques (e.g., operations, processes, methods, and methodologies) described herein, according to various embodiments.

### DETAILED DESCRIPTION

As mentioned at the outset, multicore processors have become increasingly popular in computing devices. For example, within a given processor, one or more cores may be selected to perform work for applications that are running on the processor. Moreover, multiple processors may be present, where each processor has its own set of cores. The different cores can be of different types as well, where some are higher-performing, but consume more power, while others are lower-performing, but consume less power. The cores execute instructions to provide an operating system (OS) which may include drivers that assign work to the cores and decide which cores will be active or inactive. However, various challenges are presenting in optimizing the tradeoff between performance and power consumption.

As a default, the chip manufacturer can provide algorithms which provide a reasonable tradeoff based on the expected goals of the original equipment manufacturer (OEM) who will purchase and use the chip. For example, the algorithms may be tailored for use with a laptop computer when the chips are to be user by an OEM of laptops.

In particular, the OS can include algorithms to adjust the cores used for scheduling work based on factors such as core utilization over time. However, the algorithms typically do not include a workload analysis/prediction of workload type to save power or improve performance. One approach is to provide core parking hints, which are suggestions to activate or inactivate certain cores, based on the current workload. Cores that are parked generally do not have any threads scheduled, and they will drop into very low power states. For example, the workload scenarios can be classified as bursty, sustain, idle and battery life, and a core availability mask can be updated accordingly and provided to software based on that workload classification. This can provide a performance improvement for selected limited threaded workloads.

Although, the computer OEMs may wish to provide their own core parking algorithms which are specific to their platforms and usage models. These schemes can directly override the default core mask provided by the system-on-a-chip (SoC) or other circuit. However, this approach results in sub-optimal results to the end customer, because setting a core mask based on the knowledge of applications that are currently running without knowledge of the system constraints will result in performance and power consumption degradation. The reason for the inefficiencies is that the parking overrides do not consider system aspects such as thermal/electrical constraints, power budget distribution, system loading and actual core efficiency based on current operating voltage and temperature.

A challenge is to enable the OEMs to provide input on the core mask provided to the OS while at the same time making sure that SoC level constraints are considered and an optimal parking decision is made that results in overall performance and power consumption gains.

The solutions provided herein address the above and other issues. In one aspect, a computing device includes a plurality of different types of cores arranged in one or more processors. The core types are different in terms of, e.g., performance and power consumption. For example, some cores have a higher performance (e.g., higher clock speed) but high power consumption, while other cores have lower performance (e.g., lower clock speed) and lower power consumption.

The computing device executes code to provide a driver, where the driver receives a first preference for higher performance or reduced power consumption along a performance/power consumption spectrum. The preference may also be referred to as a gear setting or an OEM preference. A second preference is provided based on the first preference and a core utilization percentage and/or foreground activity percentage. The second preference may also be referred to as a slider value. The first and second preferences may be referred to as first and second performance/power consumption preferences, respectively. These preferences represent a degree to which performance is desired over power consumption. A core mask is then selected and provided to an operating system scheduler based on the slider value and the current workload type. The preferences may extend over a set of cores on a SoC or other circuit, in one approach. As a result, the first preference can guide, without dictating, a decision of which cores are selected.

The above and other advantages will be understood further in view of the following.

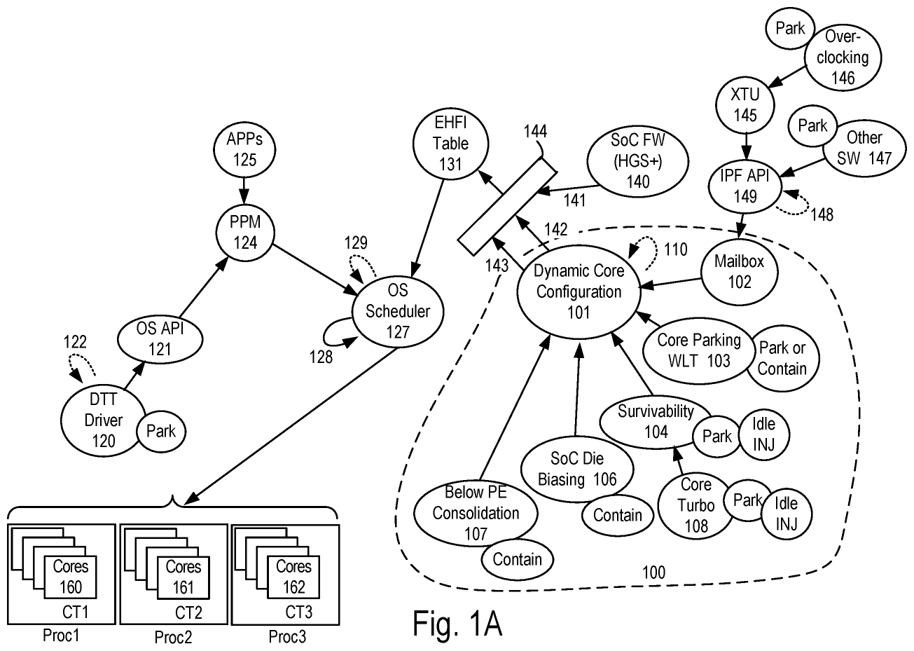

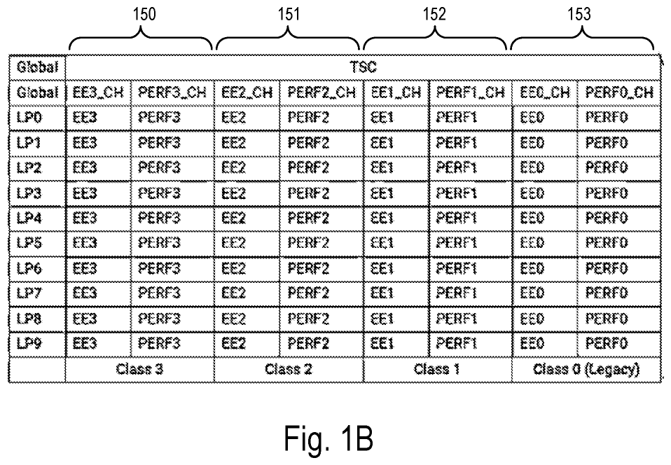

FIG. 1A depicts an example dynamic core configuration in a computing device, according to various embodiments. The configuration includes a number of processors and respective processor cores. For example, processors Proc1, Proc2 and Proc3 are depicted which each have a set of cores 160, 161 and 162, respectively. Additionally, in this example, the cores are of different types. For example, cores 160, 161 and 162 are of type CT1, CT2 and CT3, respectively. The different types may represent, e.g., different sizes, performance levels and power consumption levels. The different performance levels may have different clock speeds, where a relatively high clock speed is associated with a relatively high performance. That is, performance is an increasing function of clock speed. Within a processor, the cores may be of the same or different type.

An OS Scheduler 127 schedules work, e.g., tasks to be executed, on the cores. The OS Scheduler implements a program for assigning tasks to a processor or core from a queue of available tasks. A goal is to maintain a relatively uniform amount of work for the processor or core, while ensuring each process is completed within a reasonable time frame.

The arrow 128 represents OS parking. The dashed arrow 110 represents consolidation at the OS scheduler as an interface. The OS Scheduler receives a % of core type and rule based on utilization from a Processor Power Management (PPM) utility 124. This utility allows for system-specific customized tuning of processors. The PPM is responsive to Applications (APPs) 125 that are running and to a number of cores parked from an OS Application Programming Interface (API) 121.

The OS API in turn is responsive to instructions from a Dynamic Tuning Technology (DTT) driver 120. DTT is a system software driver configured by the system manufacturer (also known as OEM) to dynamically optimize the system for performance, battery life, and thermals. The DTT driver may contain advanced artificial intelligence (AI) and machine learning (ML)-based algorithms to enable these optimizations for performance, thermals, and battery life. OEMs configure the software specifically for their systems. The dashed arrow 122 represents consolidation at the DTT driver as an interface. The “Park” bubble indicates the DTT driver has the ability to park cores.

The OS scheduler is also responsive to an Enhanced Hardware Feedback Interface (EHFI) table 131 which provides core capability hints. The EHFI Table receives an input from a consolidation component 144. The consolidation component may in turn receive a number of inputs. One input via arrow 141 is performance (perf)/energy efficiency (EE) data from a System-On-A-Chip (SOC) Firmware (FW) 140. This firmware may implement a Hardware Guided Scheduling (HGS+) feature which prioritizes and manages the distribution of workloads, sending tasks to the best thread for the job, thereby optimizing performance per watt. Another input via arrow 142 is from a Dynamic Core Configuration (DCC) component 101 and indicates cores to contain. Containing a core refers to consolidating work on the core from other cores. This is the opposite of parking a core. Another input via arrow 143 is also from the DCC component and indicates cores to park. The dashed arrow 110 represents consolidation at the DCC component 101 as an interface.

The DCC component 101 receives a number of inputs which it uses to provide the outputs to the consolidation component 144. For example, an input is received from mailbox 102 which in turn is responsive to an IPF API 149. One example of a mailbox is the Intel® Camarillo™ Mailbox. This is a communication mechanism used in reference platforms and software development kits (SDKs). The dashed arrow 148 represents consolidation at the IPF API as an interface. The IPF API in turn in responsive to an XTU component 145 and other software (SW) 147. The “Park” bubble indicates the other SW has the ability to park cores.

XTU refers to an Extreme Tuning Utility. This is a Windows-based performance-tuning software that enables designers to overclock, monitor, and stress a system. The XTU component is responsive to an over-clocking component 146. The overclocking component can perform overclocking of a core by increasing its operating speed beyond a nominal maximum speed. The “Park” bubble indicates the over-clocking component has the ability to park cores.

Another input to the DCC 101 is received from a Core Parking Workload Type (WLT) component 103. The “Park or Contain” bubble indicates the Core Parking WLT component has the ability to park or contain cores.

Another input is from a Survivability Component 104. The “Park” bubble indicates the survivability component has the ability to park a core. The “idle INJ” bubble indicates the survivability component has the ability to perform idle injection. This involves forcing a processor to go to an idle state for a specified time each control cycle. This can be done to control the power, heat and frequency of the processor.

The Survivability Component in turn is responsive to a Core Turbo Component 108. This can enable a turbo boost technology, which is a way to automatically run a processor core faster than the marked frequency. The “Park” bubble indicates the core turbo component has the ability to park a core. The “Idle INJ” bubble indicates the core turbo component has the ability to perform idle injection.

Another input to the DCC component 101 is from a SoC Die Biasing component. This component can apply a bias to the die substrate to improve performance. The “Contain” bubble indicates the component has the ability to contain a core.

Another input is from a Below PE Consolidation component 107. PE refers to the most efficient operating frequency of a core. The “Contain” bubble indicates the component has the ability to contain a core.

The DCC 101 and the various components which provide inputs to the DCC are a group of components 100 involved in generating a core configuration mask.

In this configuration, the DCC 101 arrives at an optimal core mask for publication to the OS. This includes a provision allowing OEM's to tune for overclocking by setting the core mask such that only a few cores are exposed to the OS to improve single threaded performance. In one approach, the DCC component always honors the OC core mask request and does not apply any constraint checks or optimization on the cores hidden from the OS for overclocking. The rest of the available cores will be optimized based on electrical/thermal constrains (survivability), power budget constraints (below PE consolidation), workload type phases, SoC die biasing and opportunities to consolidate the work on the die. The DCC component can also decide when it is better to use the core mask to park or contain a core.

With the configuration of FIG. 1A, the OEM may use the Mailbox 102 to control which type of cores to activate and how many cores to park. However, the OEM does not have insight into which instruction set is being executed or if another component is taking the power budget to make intelligent core parking asks. Accordingly, using the mailbox can potentially hurt performance and power consumption rather than gaining any benefits.

Moreover, the OEM may set the core mask for overclocking purposes. However, this approach alone does not try to qualify the OEM needs with other details that are available at the SoC level such as electrical/thermal constraints, WLT phases and power budget constraints.

FIG. 1B depicts an example implementation of the Enhanced Hardware Feedback Interface (EHFI) table 131 of FIG. 1A, according to various embodiments. The EHFI table is part of a thread director technology which decides what is the best scheduling policy for the OS. The table is published to the OS. The different rows represent different logical processors (LP), e.g., LP0 to LP9. The columns pairs 150-153 represent different workload types, in the form of energy efficiency (EE) and performance (PERF). For example column 150 represents EE3 and PERF3 in a class 3, column 151 represents EE2 and PERF2 in a class 2, column 152 represents EE1 and PERF1 in a class 1, and column 153 represents EE0 and PERF0 in a class 0. EE0 to EE3 are different energy efficiencies and PERF0 to PERF3 are different performance levels.

The columns may correspond to different types of work that the processor perform such as integer, floating point and machine learning operations.

The EHFI provides to the operating system, information about the performance and energy efficiency of each CPU in the system. Each capability is given as a unit-less quantity in the range [0-255]. Higher values indicate higher capability. Energy efficiency and performance may be reported separately.

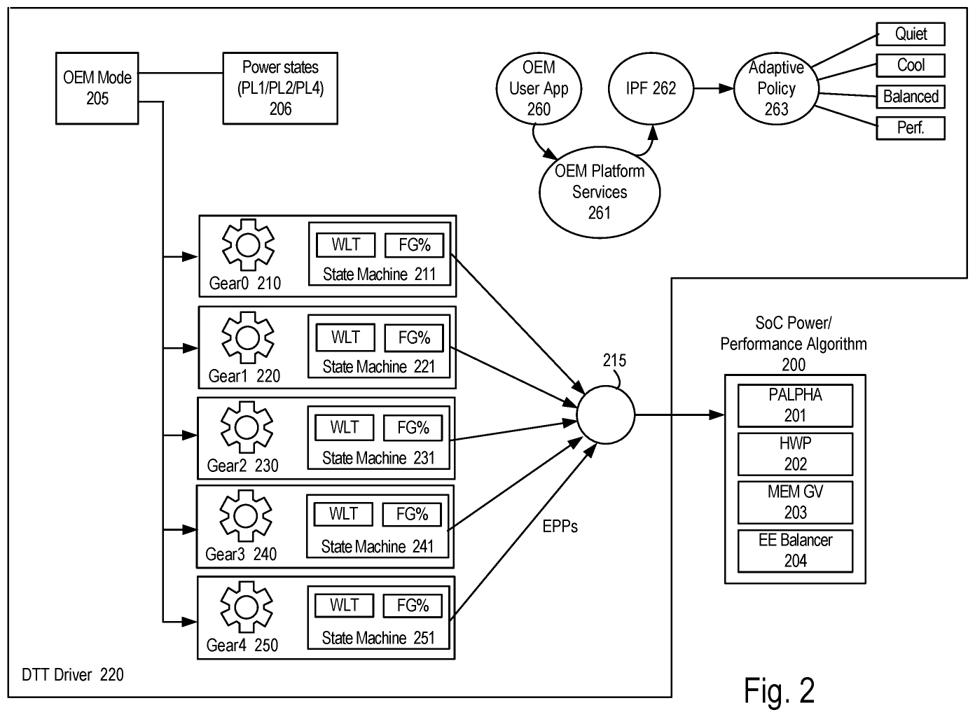

FIG. 2 depicts a high-level overview of a system in which a DTT driver 220, corresponding to the DTT driver 120 of FIG. 1A, implements energy performance preferences (EPPs) in a computing device, according to various embodiments. The DTT driver provides inputs to a SoC Power/Performance Algorithm 200. The DTT driver includes an OEM mode component 205 which provides an output in the form of a gear setting (first performance/power consumption preference).

The gear setting can be for Gear0 (block 210), Gear1 (block 220), Gear2 (block 230), Gear3 (block 240) and Gear4 (block 250). In one approach, a low gear indicates a focus on high performance over reduced power consumption, and a high gear indicates a focus on reduced power consumption over high performance. The gear value may be a setting along a performance/power consumption spectrum, where Gear0 corresponds to one end of the spectrum, where the greatest focus is on achieving high performance, even at the expense of high power consumption, and Gear4 corresponds to another end of the spectrum, where the greatest focus is on achieving low power consumption, even at the expense of reduced performance.

Each gear setting can include a state machine which outputs a respective EPP value to a node 215. For example, EPP may range from 0 to 255, where a value of 0 favors performance and a value of 255 favors energy savings (reduced power consumption). Intermediate values between 0 and 255 can correspond to a spectrum of different priorities for performance and energy savings. EPP may be stored in a register.

One gear setting is selected at a given time so that the node forwards the associated EPP value to the SoC power/performance algorithm 200. Gear0, Gear1, Gear2, Gear3 and Gear4 include state machines 211, 221, 231, 241 and 251, respectively. Each state machine can consider a workload type (WLT) and a foreground activity percentage (FG %) in setting a respective EPP value. The foreground activity of a computer or SoC is the task or application that is currently receiving the input focus and is actively running in the front of the screen. This means that the user is currently interacting with that task or application, and it is receiving the majority of the computer's processing resources and attention. For example, if a user is typing in a word processor, that word processor is the foreground activity. If the user switches to a web browser and begins scrolling through a webpage, the web browser becomes the new foreground activity. In contrast, background activity refers to other activity of the computer that is not in the foreground. For example, this could include a virus scan or other maintenance tasks.

The SoC Power/Performance Algorithm 200 includes a number of internal algorithms. PALPHA 201 involves a power (P) state, and indicates how much to optimize high frequencies, and how much energy to spend on high frequencies.

HWP 202 refers to the Hardware P-state which is determined based on utilization and other inputs. The Hardware P-State is a power management technology designed to improve energy efficiency by dynamically adjusting the processor's performance and power consumption based on workload demands. The HWP technology allows the processor to operate at different power and performance levels, known as “P-states”, depending on the current workload. The P-states range from the highest performance (PO) to the lowest power consumption (Pn).

Regarding MEM GV 203, Memory Encryption and Guarded Extensions are two related security features designed to protect sensitive data from attacks at the hardware level.

The Energy Efficient (EE) balancer 204 is a power management feature designed to help balance power consumption and performance by dynamically adjusting the power limits of the processor based on workload demands. The EE Balancer works by monitoring the processor's performance and power consumption in real-time and adjusting the power limits as needed to optimize the balance between performance and energy efficiency. When the processor is under heavy load, the power limits can be raised to allow for maximum performance. Conversely, when the workload is light, the power limits can be lowered to save energy.

Accordingly, the SoC Power/Performance Algorithm 200 adjusts factors such as core frequency, power state and power limits, but does not provide a core mask or select which cores will be active or inactive.

The OEM mode component 205 may also be responsive to a Power states component 206 which indicates a power state of the SoC. PL4 is the absolute maximum power limit that the SoC can sustain without damaging itself. It may be used for only a short period. PL1 represents the processor thermal design power. PL2 represents a maximum boost frequency level.

The DTT driver can further include an Adaptive Policy Component 263 which implements a quiet, cool, balanced or performance mode for a computer. In the quiet mode, the performance may be reduced to reduce heat and therefore allow the fan to run at a lower, quieter speed. In the cool mode, the fan runs at a higher speed to cool the computer. In the balanced mode there is a balance among performance, fan speed and noise, and heat considerations. In the performance mode, the performance is increased without regard for fan noise or heat.

The Adaptive Policy Component is responsive to an IPF component 262, which in turn in responsive to an OEM Platform Services Component 261. The Platform Services Component is a software component that provides a set of system-level services. It is typically included with chipset drivers and is installed as a background service on Windows operating systems. It provides a variety of services related to system management, performance, and security. These services include thermal management, power management, device detection and enumeration, firmware updates, and system monitoring. The component also includes support for remote management capabilities for IT administrators.

The Platform Services Component may be responsive to inputs from a user in an OEM user application 260. This application can include a user interface which allows a user to set a slider value (second performance/power consumption preference).

The OEM gears are a part of the DTT driver that the OEM can use to meet the power/performance/thermal/acoustic expectation for various platform modes such as quiet, cool, balanced and performance modes. The OEM can adjust the SoC power envelope (e.g., power states PL1/PL2/PL4) and other parameters corresponding to each gear selection. The OEM gear automatically adjusts the per-core energy performance preference (EPP) to the SoC firmware via an architectural model-specific register based on the foreground activity and the recent system usage (e.g., workload type interface-bursty, sustained, battery life or idle). The SoC FW uses the EPP to modulate the various algorithms, which in turn translates to frequency budgeting for various cores and shared resources.

With the configuration of FIG. 2, the OEM Gears influence EPP, which is used by the SoC to modulate the core frequency, and influences the shared resource frequency. However, EPP does not influence the core mask decision. Therefore, it does not solve the problem of enabling an OEM to effectively modulate the core mask as needed to meet the desires of the platform.

Moreover, the DTT is a software-based solution with limited visibility and running at a few seconds granularity. Accordingly, it does not help address concurrent scenarios which could occur with faster, e.g., millisecond, granularity.

Changing EPP alone could reduce the SoC power, but it will impact the performance score of a processor for single-threaded tasks using benchmarking tools such as Cinebench ST.

In contrast, using a combination of core mask and frequency, as discussed below, can result in optimal power and performance. With this approach, based on the workload on each processor, the operating system makes a decision of which processors to schedule work. The OEM can provide a hint which is consolidated with knowledge of the existing physical conditions of the processor. A table can be used to determine whether to park some of the cores. Or, given a specific topology of chiplets, it may be more efficient to contain some of the workload on a certain set of logical processors based on knowledge that it is better to put a workload on a specific chiplet and not start using another chiplet.

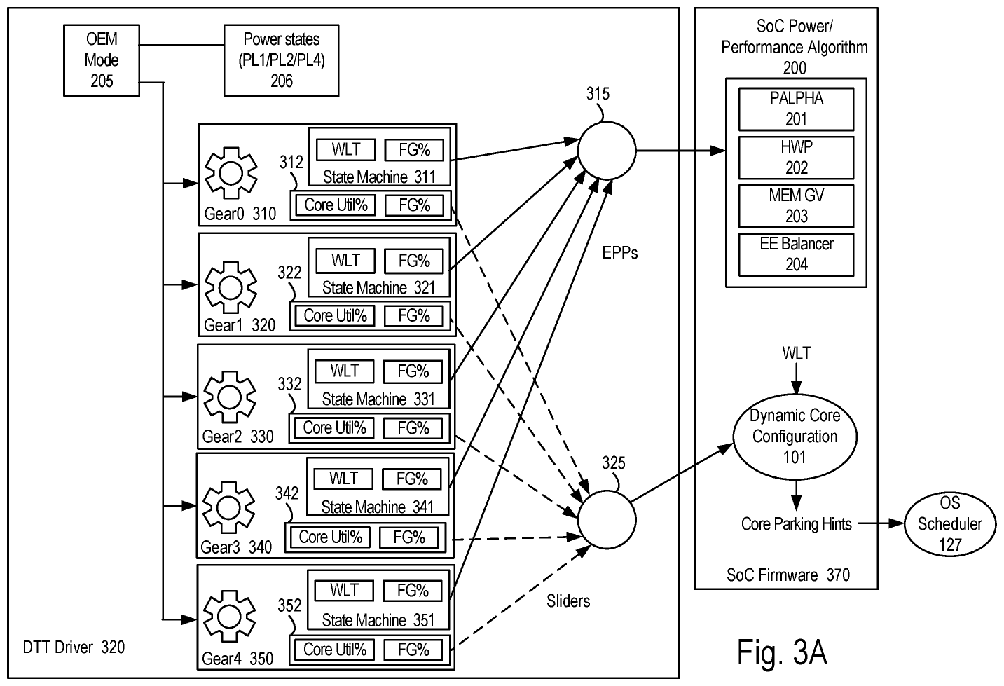

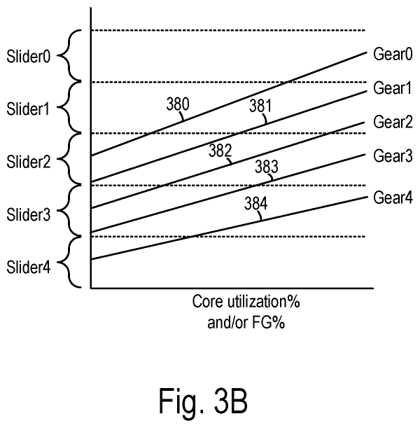

FIG. 3A depicts a high-level overview of a system in which a DTT driver 320, corresponding to the DTT driver 120 of FIG. 1A, implements EPPs and OEM preferences in a computing device, according to various embodiments. The DTT driver 320 is analogous to the DTT driver 220 in that it includes the OEM mode component 205, the Power states component 206 and the SoC Power/Performance Algorithm 200. As before, the OEM mode component provides a gear setting (first performance/power consumption preference). The setting is for Gear0 (block 310), Gear1 (block 320), Gear2 (block 330), Gear3 (block 340) and Gear4 (block 350).

Each gear setting can include a state machine which outputs a respective EPP value to a node 315, similar to FIG. 2. For example, Gear0, Gear1, Gear2, Gear3 and Gear4 include state machines 311, 321, 331, 341 and 351, respectively. Each state machine can consider a workload type (WLT) and a foreground activity percentage (FG %) in setting the EPP value.

Additionally, each gear setting includes a component which outputs a slider value to a node 325. For example, Gear0, Gear1, Gear2, Gear3 and Gear4 include components 312, 322, 332, 342 and 352, respectively. For each gear, the respective component can consider a core utilization percentage (or other metric of core utilization) and/or the foreground activity percentage (FG %) (or other metric of foreground activity) in setting the slider. The core utilization percentage is the percent of a time interval in which the core is busy executing a task. It is the percentage of the total core capacity being used in the time interval. The foreground activity was discussed above in connection with FIG. 2.

For example, the OEM may set Gear0 which corresponds to the greatest focus on achieving high performance, even at the expense of high power consumption. Generally, this goal requires activating many cores which are of the highest performance type. However, the core utilization percentage and/or the foreground activity percentage may indicate it is not necessary to activate many cores which are of the highest performance type. For example, if the core utilization percentage and/or the foreground activity percentage is relatively low, this may tend to reduce the number of cores activates and/or result in activating lower performing cores. See also FIG. 3B.

In other words, the gear setting does not dictate a particular core mask, with its associated number of active cores and core types. Instead, the gear setting together with the core utilization percentage and/or the foreground activity percentage are used to set the core mask, including selecting the number of active cores and the core types.

The term “slider” or “core mask slider” indicates a value which can vary within a spectrum of values. Similar to the gear setting, the slider represents a preference regarding performance and power consumption. A single slider value may apply to the processors and cores of an entire SoC, in one approach. In another approach, different slider values apply to different processors/cores of a SoC.

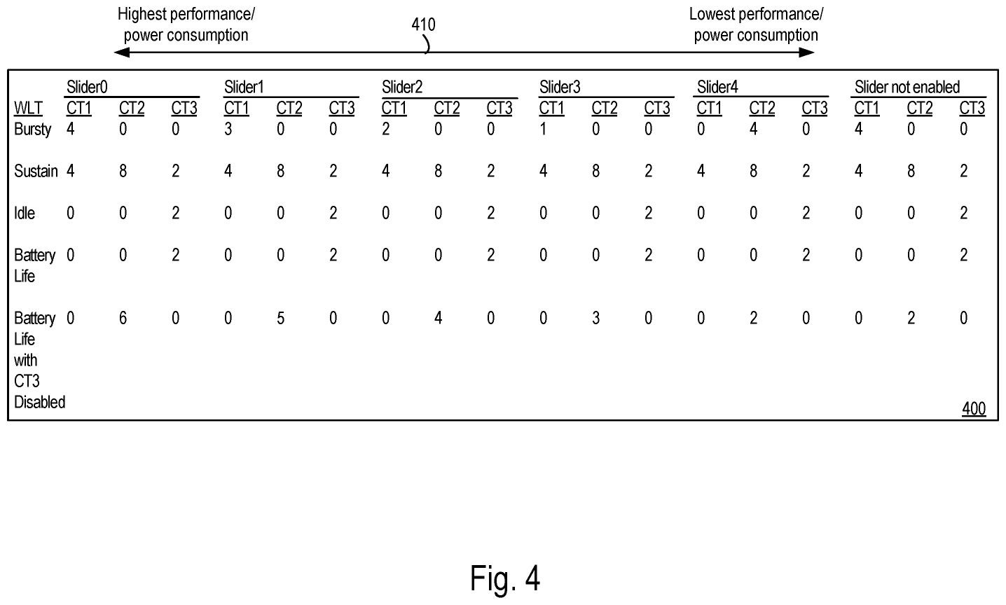

One gear setting is selected at a given time. The node 315 forwards the associated EPP value to the SoC power/performance algorithm 200, and the node 325 forwards the associated slider to the Dynamic Core Configuration (DCC) component 101 of FIG. 1A. The DCC component is responsive to the slider and the workload type (WLT) to output core parking hints to the OS scheduler 127. These are suggestions of cores which should be parked (e.g., be idle and not run any threads). The core parking hints can include a minimum and maximum number of parked cores, a time limit for parking cores and a frequency of core parking. The DCC component 101 may implement a table of core masks, in one approach, such as depicted in FIGS. 4, 6 and 7.

The SoC Power/Performance Algorithm 200 and the DCC component 101 are part of SoC Firmware 370 or other circuit firmware. For example, the firmware can be in a circuit which is part of a stacked tile/chiplet design, where the design includes multiple integrated circuits/chips within the same package. The circuit can be considered to be an apparatus, a system or circuitry.

The WLT may be updated every 0.2-1 sec., for example.

The OEM gears are used to arrive at a slider value (which is separate from the EPP) by qualifying it with core utilization on foreground tasks and the overall CPU utilization. An example of a five-level slider is provided in the table of FIG. 4. The slider can be communicated to the SoC FW using a mailbox command. The slider is used by the SoC FW to adjust the core mask for each of the inferred workload type decisions (e.g., bursty, battery life, sustained, idle, etc.). The bursty workload type involves short bursts of processor/core activity followed by periods of inactivity. For example, opening and closing applications or performing quick calculations. The battery life workload type is optimized for conserving battery life on mobile devices. It typically involves low-intensity tasks that don't require a lot of processing power, such as reading or sending emails. The sustained workload involves long periods of continuous processor/core activity, such as rendering video, compiling code, or running simulations. The idle workload type involves no processor/core activity and is essentially the opposite of sustained workload. It occurs when the device is not in use, such as when it's in sleep mode. The mixed workload type involves a combination of different types of processor/core activity, such as bursty and sustained. It's common in many real-world scenarios, such as browsing the web, streaming video, or playing games.

A single workload type can be determined for the processors and cores of an entire SoC, in one approach. In another approach, different workload types are determined for different processors/cores of a SoC.

The workload type inference determines if the final core mask would guide the OS to stop using a subset of cores, or alternatively to consolidate all work onto a subset of cores.

The slider determines the intensity of the core mask decision.

The Dynamic Core Configuration component ensures that all other inputs (overclocking hints, power constraints, etc.) are appropriately combined with the OEM gears to arrive at the optimal core mask, which is passed to the OS scheduler 127.

Similarly, there could be other SoC algorithms such as “Below PE consolidation” which try to improve the frequency in a budget constrained condition by reducing the number of active cores. All these features can be applied over the OEM sliders, allowing for a more optimized parking/contain hints.

There are other cases when SoC algorithms such as “SoC Die Biasing” would detect that using one type of core may not be optimal. Instead, another type of core should be used. The OEM slider request will be passed through these requirements and adjusted as needed to implement the performance/power consumption preference of the OEM.

The solutions improves the performance/power consumption of a computing device for OEMs when they try to adjust the number of cores exposed to the OS based on platform and application requirements. This offers a way for the OEM to gain a competitive advantage, while at same time, ultimate control on core parking stays within the chip manufacturer. Without this feature, the execution of the guidance provided by the OEM will be sub-optimal and can result in negative performance/power consumption results or overall degradation during constrained scenarios.

The solutions can reduce the SoC power substantially without affecting the system performance, especially for single-threaded workloads. Since most UI applications are single-threaded, the innovation can enable better cool, quiet and performant user experience for typical system usages.

FIG. 3B depicts example plots of slider value versus a core utilization percentage and/or a foreground activity percentage (FG %), for the different gear setting in FIG. 3A, according to various embodiments. As mentioned, for each gear, a slider value (second performance/power consumption preference) can be set based on a core utilization percentage and/or FG %. The plots provide a general idea of how this might work. In this example, a given gear setting is translated to a slider value based on the core utilization % and/or FG %. The slider value corresponding to a gear setting may be in a subset of all available slider values. For instance, plot 380 shows that Gear0 can be translated to Slider0, Slider1 or Slider2. Plot 381 shows that Gear1 can be translated to Slider1 or Slider2. Plot 382 shows that Gear2 can be translated to Slider1, Slider2 or Slider3. Plot 383 shows that Gear3 can be translated to Slider2 or Slider3. Plot 384 shows that Gear4 can be translated to Slider3 or Slider4.

Generally, when more performance is needed, due to a higher level of core utilization % and/or FG %, a slider resulting in higher-performance can be used, for each given gear setting. That is, the slider value is biased toward a relatively high performance when the at least one of a core utilization or a foreground activity is relatively high, for a given gear setting.

The gear setting (first performance/power consumption preference) represents an initial performance/power consumption preference, and it can be biased toward a relatively high performance when the core utilization percentage and/or FG % is relatively high, or toward a relatively low or reduced power consumption when the core utilization percentage and/or FG % is relatively low.

FIG. 4 depicts an example table 400 of core mask configurations cross-referenced to five sliders and five workload types, in a 4-8-2 configuration, consistent with the three core types of FIG. 1A, according to various embodiments. A core mask is selected from the table of core masks. The five sliders are represented by Slider0, Slider1, Slider2, Slider3 and Slider4. The sliders extend along a spectrum depicted by an arrow 410 from highest performance/power consumption at the left side to lowest performance/power consumption at the right side. An additional scenario involves the slider not enabled, so that there is no associated performance/power consumption preference.

The five workload types are bursty, sustain, idle, battery life, and battery life with core type CT3 disabled. The 4-8-2 configuration refers to four cores of a first type (CT1), eight cores of a second type (CT2) and two cores of a third type (CT3). In this example, CT1 has the highest performance and power consumption, CT2 has moderate/intermediate performance and power consumption, and CT3 has the lowest performance and power consumption. A CT1 core may be a relatively big core, while a CT2 core is moderate in size and a CT3 core may be smallest in size. The highest performance core type may have a highest clock speed, which is the rate at which a core executes a task.

In an example implication, the CT1 cores are in the Intel® Big Core processor, the CT2 cores are in the Intel Atom® C processor and the CT3 cores are in the Intel Atom® S processor.

The number under each core type indicates the number of cores of that type which as selected by the OS Scheduler to be active. If the number is zero, all cores of that type are inactive/parked.

For the bursty WLT, all four CT1 cores are active for Slider0, three CT1 cores are active for Slider1, two CT1 cores are active for Slider2, one CT1 core is active for Slider3, and four CT2 cores are active for Slider4. If a slider is not enabled, four CT1 cores are active. The active cores may have an EE value of 255. The non-active cores are parked. The non-active cores may have an EE value of 0. The number of active CT1 cores decreases progressively as the slider value moves away from the highest performance/power consumption and toward the lowest performance/power consumption. Once Slider4 is reached, all CT1 cores are made inactive and the next highest performance core type, CT2, is used. In some cases, the combined clock rate of four CT2 cores is comparable to or less than the clock rate of one CT1 core.

For the sustain WLT, all four CT1 cores, all eight CT2 cores and both CT3 cores are active for all slider positions and for when the slider is not enabled. In other words, all cores of all types are active.

For the idle WLT, two CT3 cores are active for all slider positions and for when the slider is not enabled. In this case, the demand on for processing power is very little, so that the lowest performance core type, CT3, can be used while the other core types are inactive. Potentially, one or more CT3 cores can be active. The workload is contained on the active cores.

For the battery life WLT, the result is the same as for the idle WLT, in one possible implementation. In this case, two CT3 cores are active for all slider positions and for when a slider is not enabled. The workload is contained on the active cores.

For the battery life WLT with CT3 disabled, six CT2 cores are active for Slider0, five CT2 cores are active for Slider1, four CT2 cores are active for Slider2, three CT2 cores are active for Slider3 and two CT2 cores are active for Slider4 and for when a slider is not enabled. The number of active CT2 cores decreases progressively as the slider value moves away from the highest performance/power consumption and toward the lowest performance/power consumption. The workload is contained on the active cores.

The table is thus read based on a slider value and a workload type to obtain a corresponding core mask. The slider value in turn is based on the OEM gear setting. WLTs.

In one option, the SoC die is biased for the battery life WLT but not for the other

For the case of the slider not enabled, the SoC slider mailbox enable will not be set.

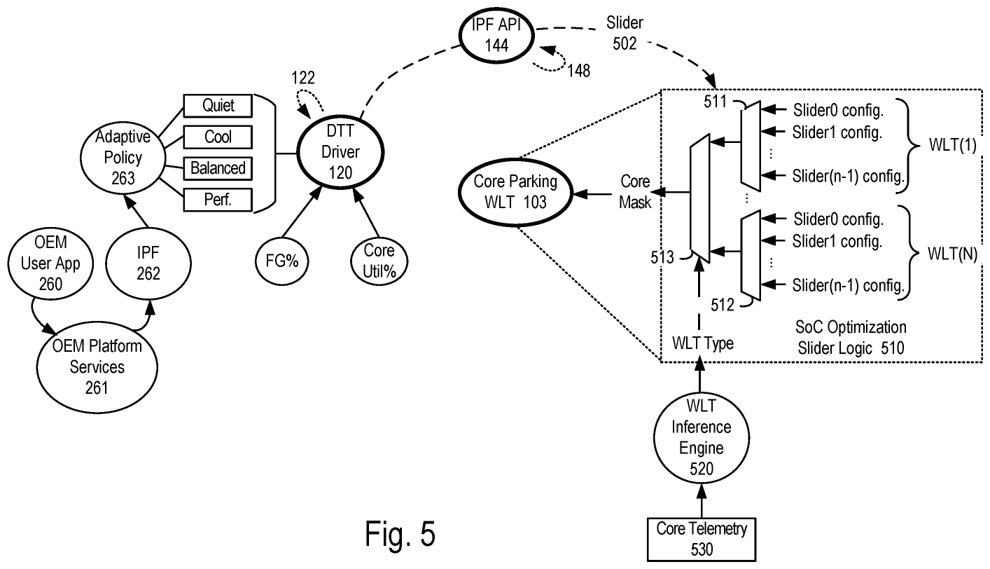

FIG. 5 depicts additional components in the dynamic core configuration of FIG. 1A, to provide a system which selects processor cores based on both EPPs and sliders, according to various embodiments. The components 103, 120 and 144, which have a thick line boundary, are repeated from FIG. 1A. The remaining components of FIG. 1A are also used as depicted in FIG. 1A but are not repeated here for simplicity. Instead, additional components are depicted which interact with the components 103, 120 and 144.

The DTT driver 120 receives the FG % and core utilization % as inputs. The DTT driver also receives information indicating a mode of the SoC/computing device, e.g., quiet, cool, balanced or performance, from the Adaptive Policy component 263. The Adaptive Policy component in turn is responsive to a sequence of components which includes the IPF 262, the OEM Platform Services 261 and the OEM User App 260. Based on the inputs it receives, the DTT driver provides a slider setting on a path 502, via the IPF API 144, to an SoC Optimization Slider Logic 510.

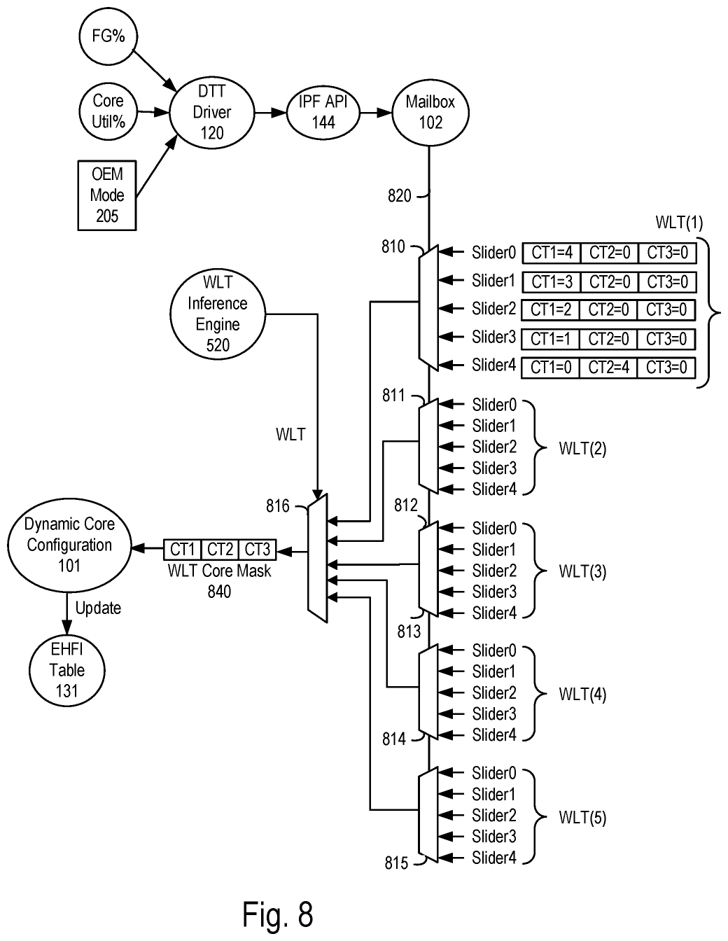

The SoC Optimization Slider Logic 510 includes N multiplexers 511, . . . , 512 which each pass one of n slider configurations to a multiplexer 513. Each set of n slider configurations, Slider0 config. to Slider(n−1) config., represents settings such as from the table of FIG. 4 indicating which cores are to be active and which cores are to be inactive, for one of N workload types, WLT(1) . . . . WLT(N). For example, WLT(1)=bursty. WLT(2)=sustain, WLT(3)=idle, WLT(4)=battery life, and WLT(5)=battery with CT3 disabled. The multiplexer 513 receives one slider configuration for each WLT, and passes a selected slider configuration based on the current WLT type as provided by a WLT Inference Engine 520. The WLT Inference Engine 520 in turn may be responsive to Core Telemetry 530 of the computing device. The telemetry provides information regarding activity on the cores which is used to classify the workload into one of a number of workload types. See also FIG. 8.

The selected slider configuration is passed as a core mask to the Core Parking WLT component 103. As mentioned, a core mask indicates the number of cores which are selected to be active for each core type. The core mask could be a sequence of three numbers, for example, when there are three core types. See also FIG. 8. The Core Parking WLT component in turn communicates with the Dynamic Core Configuration component 101 of FIG. 1A.

FIG. 5 provides a complete flow of the parking and consolidation overrides, and of the various features that try to perform an override of the core parking hints to the OS from a Hardware Guided Scheduler. At a high level, the following is an example sequence of operation.

The Hardware Guided Scheduler (HGS) hints are computed and populated locally, e.g., as Performance/Energy Efficiency (Perf/EE) hints. This corresponds to the arrow 141 in FIG. 1A.

The Dynamic Core Configuration component 101 consolidates and resolves various features that want to independently override the HGS hints. Once resolution is completed, the HGS hints are overridden with parking/consolidation hints.

The SoC sliders are used to modulate the core masks, which is further qualified with various other aspects of the SoC in the Dynamic Core Configuration component.

The following guidelines may be used to arrive at initial slider setting. Eventually, these setting can be adjusted based on post-Silicon tuning.

If the Work Load Type Inference=Bursty:
Slider0: set for performance. Leave all big cores on.
Other sliders: keep reducing one big core (CT1) for every slider setting. If the big cores are exhausted, use a number of smaller cores (CT2 or CT3) which provide a similar performance as a big die.

If the Work Load Type Inference=Battery Life:
Slider4: Leave only CT2 cores on.
Other sliders: gradually increase one CT2 core for every slider settings.

If the Work Load Type Inference=Sustain: enable all cores.

If the Work Load Type Inference=Idle: contain to smallest cores.

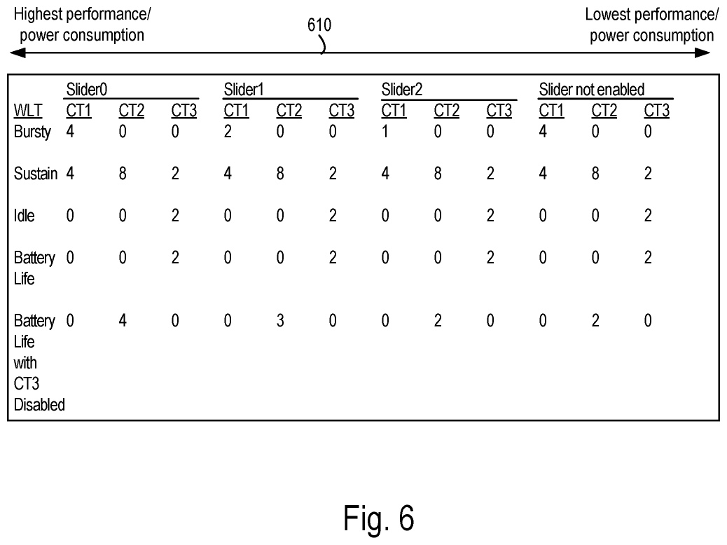

FIG. 6 depicts an example table of core mask configurations cross-referenced to three sliders and five workload types, in a 4-8-2 configuration, consistent with the three core types of FIG. 1A, according to various embodiments. The three sliders are represented by Slider0. Slider1 and Slider2. The sliders extend along a spectrum depicted by an arrow 610 from highest performance/power consumption at the left side to lowest performance/power consumption at the right side. Slider0 may represent a focus on performance, Slider1 may represent a focus on a balance between performance and power consumption, and Slider2 may represent a focus on power consumption. An additional scenario involves the slider not enabled. The five workload types and the 4-8-2 configuration are as discussed previously, e.g., in connection with FIG. 4.

For the bursty WLT, all four CT1 cores are active for Slider0, two CT1 cores are active for Slider1, and one CT1 core is active for Slider2. If a slider is not enabled, four CT1 cores are active. The number of active CT1 cores decreases progressively as the slider value moves away from the highest performance/power consumption and toward the lowest performance/power consumption.

For the sustain WLT, all four CT1 cores, all eight CT2 cores and both CT3 cores are active for all slider positions and for when the slider is not enabled.

For the idle WLT, two CT3 cores are active for all slider positions and for when the slider is not enabled.

For the battery life WLT, the result is the same as for the idle WLT, in one possible implementation.

For the battery life WLT with CT3 disabled, four CT2 cores are active for Slider0, three CT2 cores are active for Slider1, and two CT2 cores are active for Slider2 and for when a slider is not enabled. The number of active CT2 cores decreases progressively as the slider value moves away from the highest performance/power consumption and toward the lowest performance/power consumption.

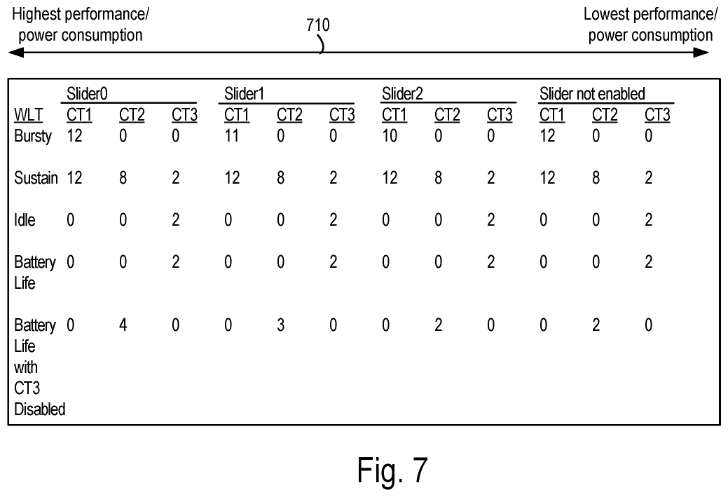

FIG. 7 depicts an example table of core mask configurations cross-referenced to three sliders and five workload types, in a 12-8-2 configuration, consistent with the three core types of FIG. 1A, according to various embodiments. The three sliders are represented by Slider0. Slider1 and Slider2. The sliders extend along a spectrum depicted by an arrow 710 from highest performance/power consumption at the left side to lowest performance/power consumption at the right side. Slider0 may represent a focus on performance, Slider1 may represent a focus on a balance between performance and power consumption, and Slider2 may represent a focus on power consumption. An additional scenario involves the slider not enabled. The 12-8-2 configuration includes twelve CT1 cores, eight CT2 cores and two CT3 cores.

For the bursty WLT, all 12 CT1 cores are active for Slider0, 11 CT1 cores are active for Slider1, and 10 CT1 cores are active for Slider2. If a slider is not enabled, 12 CT1 cores are active. The number of active CT1 cores decreases progressively as the slider value moves away from the highest performance/power consumption and toward the lowest performance/power consumption.

For the sustain WLT, all 12 CT1 cores, all 8 CT2 cores and both CT3 cores are active for all slider positions and for when the slider is not enabled.

For the idle WLT, two CT3 cores are active for all slider positions and for when the slider is not enabled.

For the battery life WLT, the result is the same as for the idle WLT, in one possible implementation.

For the battery life WLT with CT3 disabled, four CT2 cores are active for Slider0, three CT2 cores are active for Slider1, and two CT2 cores are active for Slider2 and for when a slider is not enabled. The number of active CT2 cores decreases progressively as the slider value moves away from the highest performance/power consumption and toward the lowest performance/power consumption.

FIG. 8 depicts an example implementation of a system for updating the EHFI table 131 of FIG. 1A based on EPPs and sliders, consistent with the table of FIG. 4, according to various embodiments. A set of sliders, Slider0 to Slider4, are provided for each workload type, WLT(1) to WLT(4). The sliders for WLT(1) are depicted in detail as an example. Slider0 is defined by the set of values 4, 0 and 0 for CT1, CT2 and CT3, respectively. Slider1 is defined by the set of values 3, 0 and 0 for CT1, CT2 and CT3, respectively. Slider2 is defined by the set of values 2, 0 and 0 for CT1, CT2 and CT3, respectively. Slider3 is defined by the set of values 1, 0 and 0 for CT1, CT2 and CT3, respectively. Slider4 is defined by the set of values 0, 4 and 0 for CT1, CT2 and CT3, respectively.

The sliders for WLT(1), WLT(2), WLT(3), WLT(4) and WLT(5) are input to multiplexers 810, 811, 812, 813, 814 and 815, respectively. Based on a control signal on a path 820 from the mailbox 102, each multiplexer passes one of the sliders to a multiplexer 816. The mailbox is responsive to a sequence of components including the IPF API 144 and the DTT Driver 120. The DTT Driver is responsive to the FG %, the core utilization percent and the OEM mode 205.

The multiplexer 816 passes one of its inputs in response to a WLT signal from the WLT Inference Engine 520 of FIG. 5 to provide a WLT Core Mask 840. This is a core mask based on the WLT and the slider. The core mask is provided to the Dynamic Core Configuration component 101 which, in response, updates the EHFI Table 131. The WLT Inference Engine may employ machine learning techniques to identify the WLT. For example, different patterns of historic activity may be classified as being of different workload types. These classifications could be based on the processor at issue or based on a population of processors. This is a training process for the machine learning. Subsequently, in use, a detected activity pattern is compared to the historic patterns to see which classification of workload type is a closest match.

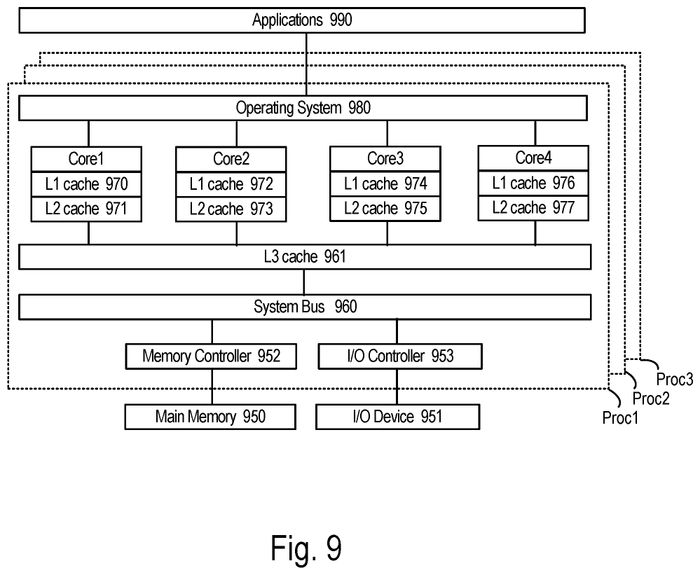

FIG. 9 depicts an example implementation of the set of multi-core processors Proc1. Proc2 and Proc3 of FIG. 1A, according to various embodiments. The processors may be on a SoC, for example, and each include a memory controller and an I/O controller to communicate with a common main memory 950 and I/O device 951, respectively. For example, the processor Proc1 includes a memory controller 952 and an I/O controller 953. These controllers communicate with an L3 cache via a system bus 960. The L3 cache is a specialized memory to improve the performance of the L1 and L2 caches, which are significantly faster than the L3 cache. With a multicore processor, each core can have dedicated L1 and L2 caches, but share an L3 cache. L1 cache is memory that is directly built into the microprocessor. It is the fastest cache memory but is limited in size. L2 cache is memory that is located outside and separate from the microprocessor chip core, but it is on the same processor chip package.

For example, a first core, Core1, includes an L1 cache 970 and an L2 cache 971. A second core, Core2, includes an L1 cache 972 and an L2 cache 973. A third core, Core3, includes an L1 cache 974 and an L2 cache 975. A fourth core, Core4, includes an L1 cache 976 and an L2 cache 977. The cores execute code to provide an operating system 980 on which applications 990 can run. In some case, different operating systems are provided on different cores.

The main memory and caches may store instructions which are to be executed by the processor cores to provide the features described herein.

Note that while the description is focused on processor cores, the definition of a core can be extended to include a graphics processor, a video processor, a machine learning acceleration circuit, etc. For example, the solutions disclosed can extend to a framework such as oneAPI to schedule the work on IA cores, GT, VPU etc. OneAPI refers to an open, cross-architecture programming model that frees developers to use a single code base across multiple architectures. IA core refers to an Intel® Architecture core, which is a central processing unit (CPU). GT refers to a Graphics Technology circuit, which is a type of circuit in a computer that is responsible for generating and rendering images on a display. It is also known as a graphics processing unit (GPU). VPU refers to a Visual Processing Unit, which is a specialized processing unit or chip designed to handle image and video data more efficiently than a general-purpose CPU.

Moreover, note that the solutions provided herein can be implemented fully in software or a driver. For example, instead of having the core mask in the processor hardware, software can be provided which performs a workload characterization and communicates directly to the OS, where the OS does core parking. The solutions can also encompass the use case for a graphics (GFX) accelerator. In this case, the software may run on the core while the mask is for GFX execution units. A graphics accelerator is a circuit that is optimized for computations for three-dimensional computer graphics.

The above solutions can be combined as well.

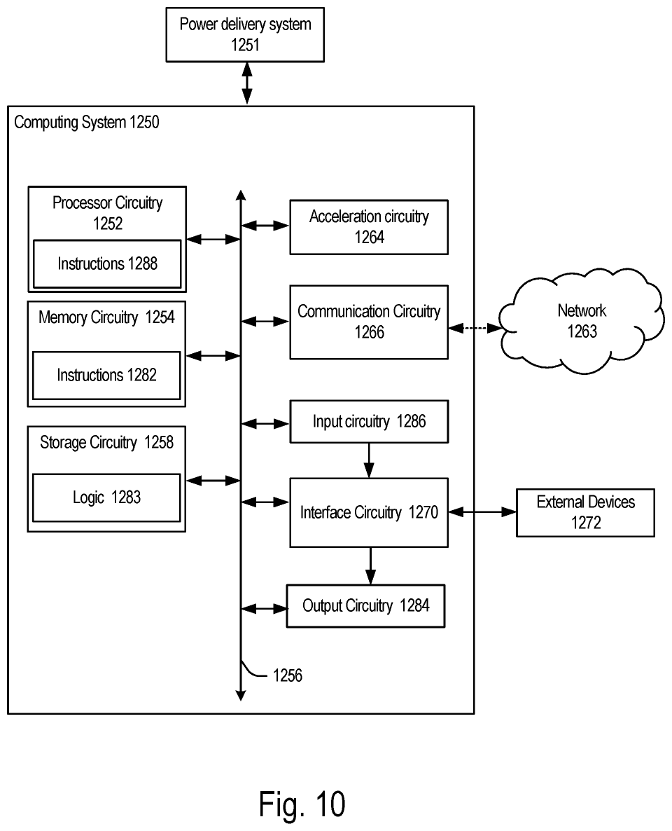

FIG. 10 illustrates an example of components that may be present in a computing system 1250 for implementing the techniques (e.g., operations, processes, methods, and methodologies) described herein. The processor circuitry 1252 may represent the processors, cores, configurations, tables and systems described above, for example.

The computing system 1250 may be powered by a power delivery subsystem 1251 and include any combinations of the hardware or logical components referenced herein. The components may be implemented as ICs, portions thereof, discrete electronic devices, or other modules, instruction sets, programmable logic or algorithms, hardware, hardware accelerators, software, firmware, or a combination thereof adapted in the computing system 1250, or as components otherwise incorporated within a chassis of a larger system. For one embodiment, at least one processor 1252 may be packaged together with computational logic 1282 and configured to practice aspects of various example embodiments described herein to form a System in Package (SiP) or a System on Chip (SoC).

The system 1250 includes processor circuitry in the form of one or more processors 1252. The processor circuitry 1252 includes circuitry such as, but not limited to one or more processor cores and one or more of cache memory, low drop-out voltage regulators (LDOs), interrupt controllers, serial interfaces such as SPI, 12C or universal programmable serial interface circuit, real time clock (RTC), timer-counters including interval and watchdog timers, general purpose I/O, memory card controllers such as secure digital/multi-media card (SD/MMC) or similar, interfaces, mobile industry processor interface (MIPI) interfaces and Joint Test Access Group (JTAG) test access ports. In some implementations, the processor circuitry 1252 may include one or more hardware accelerators (e.g., same or similar to acceleration circuitry 1264), which may be microprocessors, programmable processing devices (e.g., FPGA, ASIC, etc.), or the like. The one or more accelerators may include, for example, computer vision and/or deep learning accelerators. In some implementations, the processor circuitry 1252 may include on-chip memory circuitry, which may include any suitable volatile and/or non-volatile memory, such as DRAM, SRAM, EPROM, EEPROM, Flash memory, solid-state memory, and/or any other type of memory device technology, such as those discussed herein

The processor circuitry 1252 may include, for example, one or more processor cores (CPUs), application processors, GPUs, RISC processors, Acorn RISC Machine (ARM) processors, CISC processors, one or more DSPs, one or more FPGAs, one or more PLDs, one or more ASICs, one or more baseband processors, one or more radio-frequency integrated circuits (RFIC), one or more microprocessors or controllers, a multi-core processor, a multithreaded processor, an ultra-low voltage processor, an embedded processor, or any other known processing elements, or any suitable combination thereof. The processors (or cores) 1252 may be coupled with or may include memory/storage and may be configured to execute instructions stored in the memory/storage to enable various applications or operating systems to run on the platform 1250. The processors (or cores) 1252 is configured to operate application software to provide a specific service to a user of the platform 1250. In some embodiments, the processor(s) 1252 may be a special-purpose processor(s)/controller(s) configured (or configurable) to operate according to the various embodiments herein.

As examples, the processor(s) 1252 may include an Intel® Architecture Core™ based processor such as an i3, an i5, an i7, an i9 based processor; an Intel® microcontroller-based processor such as a Quark™, an Atom™, or other MCU-based processor; Pentium® processor(s), Xcon® processor(s), or another such processor available from Intel® Corporation, Santa Clara, California. However, any number other processors may be used, such as one or more of Advanced Micro Devices (AMD) Zen® Architecture such as Ryzen® or EPYC® processor(s), Accelerated Processing Units (APUs), MxGPUs, Epyc® processor(s), or the like; A5-A12 and/or S1-S4 processor(s) from Apple® Inc., Snapdragon™ or Centriq™ processor(s) from Qualcomm® Technologies, Inc., Texas Instruments, Inc.® Open Multimedia Applications Platform (OMAP)™ processor(s); a MIPS-based design from MIPS Technologies, Inc. such as MIPS Warrior M-class, Warrior I-class, and Warrior P-class processors; an ARM-based design licensed from ARM Holdings, Ltd., such as the ARM Cortex-A, Cortex-R, and Cortex-M family of processors; the ThunderX2® provided by Cavium™, Inc.; or the like. In some implementations, the processor(s) 1252 may be a part of a system on a chip (SoC), System-in-Package (SiP), a multi-chip package (MCP), and/or the like, in which the processor(s) 1252 and other components are formed into a single integrated circuit, or a single package, such as the Edison™ or Galileo™ SoC boards from Intel® Corporation. Other examples of the processor(s) 1252 are mentioned elsewhere in the present disclosure.

The system 1250 may include or be coupled to acceleration circuitry 1264, which may be embodied by one or more AI/ML accelerators, a neural compute stick, neuromorphic hardware, an FPGA, an arrangement of GPUs, one or more SoCs (including programmable SoCs), one or more CPUs, one or more digital signal processors, dedicated ASICs (including programmable ASICs), PLDs such as complex (CPLDs) or high complexity PLDs (HCPLDs), and/or other forms of specialized processors or circuitry designed to accomplish one or more specialized tasks. These tasks may include AI/ML processing (e.g., including training, inferencing, and classification operations), visual data processing, network data processing, object detection, rule analysis, or the like. In FPGA-based implementations, the acceleration circuitry 1264 may comprise logic blocks or logic fabric and other interconnected resources that may be programmed (configured) to perform various functions, such as the procedures, methods, functions, etc. of the various embodiments discussed herein. In such implementations, the acceleration circuitry 1264 may also include memory cells (e.g., EPROM, EEPROM, flash memory, static memory (e.g., SRAM, anti-fuses, etc.) used to store logic blocks, logic fabric, data, etc. in LUTs and the like.

In some implementations, the processor circuitry 1252 and/or acceleration circuitry 1264 may include hardware elements specifically tailored for machine learning and/or artificial intelligence (AI) functionality. In these implementations, the processor circuitry 1252 and/or acceleration circuitry 1264 may be, or may include, an AI engine chip that can run many different kinds of AI instruction sets once loaded with the appropriate weightings and training code. Additionally or alternatively, the processor circuitry 1252 and/or acceleration circuitry 1264 may be, or may include, AI accelerator(s), which may be one or more of the aforementioned hardware accelerators designed for hardware acceleration of AI applications. As examples, these processor(s) or accelerators may be a cluster of artificial intelligence (AI) GPUs, tensor processing units (TPUs) developed by Google® Inc., Real AI Processors (RAPS™) provided by AlphaICs®, Nervana™ Neural Network Processors (NNPs) provided by Intel® Corp., Intel® Movidius™ Myriad™ X Vision Processing Unit (VPU), NVIDIA® PX™ based GPUs, the NM500 chip provided by General Vision®, Hardware 3 provided by Tesla®, Inc., an Epiphany™ based processor provided by Adapteva®, or the like. In some embodiments, the processor circuitry 1252 and/or acceleration circuitry 1264 and/or hardware accelerator circuitry may be implemented as AI accelerating co-processor(s), such as the Hexagon 1285 DSP provided by Qualcomm®, the PowerVR 2NX Neural Net Accelerator (NNA) provided by Imagination Technologies Limited®, the Neural Engine core within the Apple® A11 or A12 Bionic SoC, the Neural Processing Unit (NPU) within the HiSilicon Kirin 970 provided by Huawei®, and/or the like. In some hardware-based implementations, individual subsystems of system 1250 may be operated by the respective AI accelerating co-processor(s), AI GPUs, TPUs, or hardware accelerators (e.g., FPGAs, ASICs, DSPs, SoCs, etc.), etc., that are configured with appropriate logic blocks, bit stream(s), etc. to perform their respective functions.

The system 1250 also includes system memory 1254. Any number of memory devices may be used to provide for a given amount of system memory. As examples, the memory 1254 may be, or include, volatile memory such as random access memory (RAM), static RAM (SRAM), dynamic RAM (DRAM), synchronous DRAM (SDRAM), RAMBUS® Dynamic Random Access Memory (RDRAM®), and/or any other desired type of volatile memory device. Additionally or alternatively, the memory 1254 may be, or include, non-volatile memory such as read-only memory (ROM), erasable programmable ROM (EPROM), electrically erasable programmable (EEPROM), flash memory, non-volatile RAM, ferroelectric RAM, phase-change memory (PCM), flash memory, and/or any other desired type of non-volatile memory device. Access to the memory 1254 is controlled by a memory controller. The individual memory devices may be of any number of different package types such as single die package (SDP), dual die package (DDP) or quad die package (Q17P). Any number of other memory implementations may be used, such as dual inline memory modules (DIMMs) of different varieties including but not limited to microDIMMs or MiniDIMMs.

Storage circuitry 1258 provides persistent storage of information such as data, applications, operating systems and so forth. In an example, the storage 1258 may be implemented via a solid-state disk drive (SSDD) and/or high-speed electrically erasable memory (commonly referred to as “flash memory”). Other devices that may be used for the storage 1258 include flash memory cards, such as SD cards, microSD cards, XD picture cards, and the like, and USB flash drives. In an example, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, phase change RAM (PRAM), resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a Domain Wall (DW) and Spin Orbit Transfer (SOT) based device, a thyristor based memory device, a hard disk drive (HDD), micro HDD, of a combination thereof, and/or any other memory. The memory circuitry 1254 and/or storage circuitry 1258 may also incorporate three-dimensional (3D) cross-point (XPOINT) memories from Intel® and Micron®.

The memory circuitry 1254 and/or storage circuitry 1258 is/are configured to store computational logic 1283 in the form of software, firmware, microcode, or hardware-level instructions to implement the techniques described herein. The computational logic 1283 may be employed to store working copies and/or permanent copies of programming instructions, or data to create the programming instructions, for the operation of various components of system 1250 (e.g., drivers, libraries, application programming interfaces (APIs), etc.), an operating system of system 1250, one or more applications, and/or for carrying out the embodiments discussed herein. The computational logic 1283 may be stored or loaded into memory circuitry 1254 as instructions 1282, or data to create the instructions 1282, which are then accessed for execution by the processor circuitry 1252 to carry out the functions described herein. The processor circuitry 1252 and/or the acceleration circuitry 1264 accesses the memory circuitry 1254 and/or the storage circuitry 1258 over the interconnect (IX) 1256. The instructions 1282 direct the processor circuitry 1252 to perform a specific sequence or flow of actions, for example, as described with respect to flowchart(s) and block diagram(s) of operations and functionality depicted previously. The various elements may be implemented by assembler instructions supported by processor circuitry 1252 or high-level languages that may be compiled into instructions 1288, or data to create the instructions 1288, to be executed by the processor circuitry 1252. The permanent copy of the programming instructions may be placed into persistent storage devices of storage circuitry 1258 in the factory or in the field through, for example, a distribution medium (not shown), through a communication interface (e.g., from a distribution server (not shown)), over-the-air (OTA), or any combination thereof.

The IX 1256 couples the processor 1252 to communication circuitry 1266 for communications with other devices, such as a remote server (not shown) and the like. The communication circuitry 1266 is a hardware element, or collection of hardware elements, used to communicate over one or more networks 1263 and/or with other devices. In one example, communication circuitry 1266 is, or includes, transceiver circuitry configured to enable wireless communications using any number of frequencies and protocols such as, for example, the Institute of Electrical and Electronics Engineers (IEEE) 802.11 (and/or variants thereof), IEEE 802.23.4, Bluetooth® and/or Bluetooth® low energy (BLE), ZigBee®, LoRaWAN™ (Long Range Wide Area Network), a cellular protocol such as 3GPP LTE and/or Fifth Generation (5G)/New Radio (NR), and/or the like. Additionally or alternatively, communication circuitry 1266 is, or includes, one or more network interface controllers (NICs) to enable wired communication using, for example, an Ethernet connection, Controller Area Network (CAN), Local Interconnect Network (LIN), DeviceNet, ControlNet, Data Highway+, or PROFINET, among many others.

The IX 1256 also couples the processor 1252 to interface circuitry 1270 that is used to connect system 1250 with one or more external devices 1272. The external devices 1272 may include, for example, sensors, actuators, positioning circuitry (e.g., global navigation satellite system (GNSS)/Global Positioning System (GPS) circuitry), client devices, servers, network appliances (e.g., switches, hubs, routers, etc.), integrated photonics devices (e.g., optical neural network (ONN) integrated circuit (IC) and/or the like), and/or other like devices.

In some optional examples, various input/output (I/O) devices may be present within or connected to, the system 1250, which are referred to as input circuitry 1286 and output circuitry 1284. The input circuitry 1286 and output circuitry 1284 include one or more user interfaces designed to enable user interaction with the platform 1250 and/or peripheral component interfaces designed to enable peripheral component interaction with the platform 1250. Input circuitry 1286 may include any physical or virtual means for accepting an input including, inter alia, one or more physical or virtual buttons (e.g., a reset button), a physical keyboard, keypad, mouse, touchpad, touchscreen, microphones, scanner, headset, and/or the like. The output circuitry 1284 may be included to show information or otherwise convey information, such as sensor readings, actuator position(s), or other like information. Data and/or graphics may be displayed on one or more user interface components of the output circuitry 1284. Output circuitry 1284 may include any number and/or combinations of audio or visual display, including, inter alia, one or more simple visual outputs/indicators (e.g., binary status indicators (e.g., light emitting diodes (LEDs)) and multi-character visual outputs, or more complex outputs such as display devices or touchscreens (e.g., Liquid Crystal Displays (LCD), LED displays, quantum dot displays, projectors, etc.), with the output of characters, graphics, multimedia objects, and the like being generated or produced from the operation of the platform 1250. The output circuitry 1284 may also include speakers and/or other audio emitting devices, printer(s), and/or the like. Additionally or alternatively, sensor(s) may be used as the input circuitry 1284 (e.g., an image capture device, motion capture device, or the like) and one or more actuators may be used as the output device circuitry 1284 (e.g., an actuator to provide haptic feedback or the like). Peripheral component interfaces may include, but are not limited to, a non-volatile memory port, a USB port, an audio jack, a power supply interface, etc. In some embodiments, a display or console hardware, in the context of the present system, may be used to provide output and receive input of an edge computing system; to manage components or services of an edge computing system; identify a state of an edge computing component or service; or to conduct any other number of management or administration functions or service use cases.

The components of the system 1250 may communicate over the IX 1256. The IX 1256 may include any number of technologies, including ISA, extended ISA, I2C, SPI, point-to-point interfaces, power management bus (PMBus), PCI, PCIe, PCIx, Intel® UPI, Intel® Accelerator Link, Intel® CXL, CAPI, OpenCAPI, Intel® QPI, UPI, Intel® OPA IX, RapidIO™ system IXs, CCIX, Gen-Z Consortium IXs, a HyperTransport interconnect, NVLink provided by NVIDIA®, a Time-Trigger Protocol (TTP) system, a FlexRay system, PROFIBUS, and/or any number of other IX technologies. The IX 1256 may be a proprietary bus, for example, used in a SoC based system.

The number, capability, and/or capacity of the elements of system 1250 may vary, depending on whether computing system 1250 is used as a stationary computing device (e.g., a server computer in a data center, a workstation, a desktop computer, etc.) or a mobile computing device (e.g., a smartphone, tablet computing device, laptop computer, game console, IoT device, etc.). In various implementations, the computing device system 1250 may comprise one or more components of a data center, a desktop computer, a workstation, a laptop, a smartphone, a tablet, a digital camera, a smart appliance, a smart home hub, a network appliance, and/or any other device/system that processes data.

The techniques described herein can be performed partially or wholly by software or other instructions provided in a machine-readable storage medium (e.g., memory). The software is stored as processor-executable instructions (e.g., instructions to implement any other processes discussed herein). Instructions associated with the flowchart (and/or various embodiments) and executed to implement embodiments of the disclosed subject matter may be implemented as part of an operating system or a specific application, component, program, object, module, routine, or other sequence of instructions or organization of sequences of instructions.

The storage medium can be a tangible, non-transitory computer-readable or machine-readable medium such as read only memory (ROM), random access memory (RAM), flash memory devices, floppy and other removable disks, magnetic storage media, optical storage media (e.g., Compact Disk Read-Only Memory (CD ROMS), Digital Versatile Disks (DVDs)), among others.

The storage medium may be included, e.g., in a communication device, a computing device, a network device, a personal digital assistant, a manufacturing tool, a mobile communication device, a cellular phone, a notebook computer, a tablet, a game console, a set top box, an embedded system, a TV (television), or a personal desktop computer.

Some non-limiting examples of various embodiments are presented below.

Example 1 includes an apparatus, comprising: one or more memories to store instructions; and one or more processors to execute the instructions to: receive a first preference for performance or reduced power consumption for a plurality of sets of cores; and select a core mask for the plurality of sets of cores based on the first preference, a workload type, and at least one of a core utilization or a foreground activity.

Example 2 includes the apparatus of Example 1, wherein: the plurality of sets of cores are of different types; each different type has a different performance and power consumption; and the core mask indicates a number of active cores for each type of the different types.

Example 3 includes the apparatus of Example 1 or 2, wherein the setting is selected from among a plurality of first preferences which extend in a performance/power consumption spectrum.

Example 4 includes the apparatus of any one of Examples 1 to 3, wherein the workload type is determined from among a plurality of workload types comprising bursty, sustained, battery life and idle.

Example 5 includes the apparatus of any one of Examples 1 to 4, wherein the first preference is received from an original equipment manufacturer.

Example 6 includes the apparatus of any one of Examples 1 to 5, wherein: the core mask is selected from a table of core masks; the core masks in the table are cross-referenced to different workload types and to different second preferences; one of the slider values is selected based on the setting and the at least one of the core utilization or the foreground activity; and the selected core mask is cross-referenced to the one of the second preference and the workload type.

Example 7 includes the apparatus of Example 6, wherein the second preferences extend in a performance/power consumption spectrum.

Example 8 includes the apparatus of Examples 6 or 7, wherein the second preferences correspond to different core masks with different numbers of active cores, for at least one of the different workload types.

Example 9 includes the apparatus of any one of Examples 6 to 8, wherein: the plurality of sets of cores are of different types; each different type has a different performance; and when the workload type is bursty, the different slider values correspond to different second preferences with different numbers of active cores, for a highest performance core type of the different types.

Example 9a includes a method performed by an apparatus comprising: receiving a first preference for performance or reduced power consumption for a plurality of sets of cores; and selecting a core mask for the plurality of sets of cores based on the first preference, a workload type, and at least one of a core utilization or a foreground activity.

Example 9b includes an apparatus comprising means to perform the method of Example 9a.

Example 9c includes non-transitory machine-readable storage including machine-readable instructions that, when executed, cause a processor or other circuit or computing device to implement the method of Example 9a.

Example 9d includes a computer program comprising instructions which, when the program is executed by a computer, cause the computer to carry out the method of Example 9a.

Example 10 includes an apparatus, comprising: a plurality of sets of cores, wherein each set is of a different type, and each different type has a different performance and power consumption; and a driver to indicate a preference for performance or reduced power consumption for the plurality of sets of cores, wherein the preference is based on an original equipment manufacturer setting and at least one of a core utilization or a foreground activity; and firmware to provide core parking hints to an operating system scheduler in response to the preference.

Example 11 includes the apparatus of Example 10, wherein the original equipment manufacturer setting is selected from among a plurality of settings which extend in a performance/power consumption spectrum.

Example 12 includes the apparatus of Example 10, wherein the core parking hints comprise a selected core mask which is based on the preference and a workload type of the apparatus.

Example 13 includes the apparatus of Example 12, wherein the firmware comprises a table of core masks and the selected core mask is selected from the table based on the preference and a workload type of the apparatus.

Example 14 includes the apparatus of Example 13, wherein the workload type is determined from among a plurality of workload types comprising bursty, sustained, battery life and idle.

Example 14a includes a method performed by an apparatus comprising: indicating a preference for performance or reduced power consumption for a plurality of sets of cores, wherein the preference is based on an original equipment manufacturer setting and at least one of a core utilization or a foreground activity; and providing core parking hints to an operating system scheduler in response to the preference.

Example 14b includes an apparatus comprising means to perform the method of Example 14a.

Example 14c includes non-transitory machine-readable storage including machine-readable instructions that, when executed, cause a processor or other circuit or computing device to implement the method of Example 14a.

Example 14d includes a computer program comprising instructions which, when the program is executed by a computer, cause the computer to carry out the method of Example 14a.

Example 15 includes a method, comprising: obtaining a first preference for high performance or low power consumption for a plurality of sets of cores, wherein the first preference is selected from among a plurality of preferences which extend in a performance/power consumption spectrum; determining a second preference based on the first preference and at least one of a core utilization or a foreground activity; and reading a table to determine a core mask which is cross-reference to the second preference and a workload type.

Example 16 includes the method of Example 15, wherein the value is biased toward a relatively high performance when the at least one of a core utilization or a foreground activity is relatively high.

Example 17 includes the method of Example 15 or 16, wherein the core mask provides core parking hints to an operating system scheduler.

Example 18 includes the method of any one of Examples 15 to 17, further comprising receiving the first preference from an original equipment manufacturer.

Example 19 includes the method of any one of Examples 15 to 18, wherein the one or more processors comprise a plurality of sets of cores, and the core mask indicates a number of active cores for each set of cores of the plurality of sets of cores.

Example 20 includes the method of any one of Example 19, wherein a performance and power consumption is different for each set of cores of the plurality of sets of cores.

Example 21 includes a computer program comprising instructions which, when the program is executed by a computer, cause the computer to carry out the method of any one of Examples 15 to 20.

In the present detailed description, reference is made to the accompanying drawings that form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

The terms “substantially,” “close,” “approximately,” “near,” and “about,” generally refer to being within +/−10% of a target value. Unless otherwise specified the use of the ordinal adjectives “first,” “second,” and “third,” etc., to describe a common object, merely indicate that different instances of like objects are being referred to, and are not intended to imply that the objects so described must be in a given sequence, either temporally, spatially, in ranking or in any other manner.

For the purposes of the present disclosure, the phrases “A and/or B” and “A or B” mean (A), (B), or (A and B). For the purposes of the present disclosure, the phrase “A, B, and/or C” means (A), (B), (C), (A and B), (A and C), (B and C), or (A, B, and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the term “circuitry” may refer to, be part of, or include an Application Specific Integrated Circuit (ASIC), an electronic circuit, a processor (shared, dedicated, or group), a combinational logic circuit, and/or other suitable hardware components that provide the described functionality. As used herein, “computer-implemented method” may refer to any method executed by one or more processors, a computer system having one or more processors, a mobile device such as a smartphone (which may include one or more processors), a tablet, a laptop computer, a set-top box, a gaming console, and so forth.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or link, and/or the like.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment.” or “some embodiments” are not necessarily all referring to the same embodiments. If the specification states a component, feature, structure, or characteristic “may,” “might,” or “could” be included, that particular component, feature, structure, or characteristic is not required to be included. If the specification or claim refers to “a” or “an” element, that does not mean there is only one of the elements. If the specification or claims refer to “an additional” element, that does not preclude there being more than one of the additional elements.

Furthermore, the particular features, structures, functions, or characteristics may be combined in any suitable manner in one or more embodiments. For example, a first embodiment may be combined with a second embodiment anywhere the particular features, structures, functions, or characteristics associated with the two embodiments are not mutually exclusive.

While the disclosure has been described in conjunction with specific embodiments thereof, many alternatives, modifications and variations of such embodiments will be apparent to those of ordinary skill in the art in light of the foregoing description. The embodiments of the disclosure are intended to embrace all such alternatives, modifications, and variations as to fall within the broad scope of the appended claims.

In addition, well-known power/ground connections to integrated circuit (IC) chips and other components may or may not be shown within the presented figures, for simplicity of illustration and discussion, and so as not to obscure the disclosure. Further, arrangements may be shown in block diagram form in order to avoid obscuring the disclosure, and also in view of the fact that specifics with respect to implementation of such block diagram arrangements are highly dependent upon the platform within which the present disclosure is to be implemented (i.e., such specifics should be well within purview of one skilled in the art). Where specific details (e.g., circuits) are set forth in order to describe example embodiments of the disclosure, it should be apparent to one skilled in the art that the disclosure can be practiced without, or with variation of, these specific details. The description is thus to be regarded as illustrative instead of limiting.

An abstract is provided that will allow the reader to ascertain the nature and gist of the technical disclosure. The abstract is submitted with the understanding that it will not be used to limit the scope or meaning of the claims. The following claims are hereby incorporated into the detailed description, with each claim standing on its own as a separate embodiment.

What is claimed is:

1. An apparatus, comprising:
one or more memories to store instructions; and
one or more processors to execute the instructions to:
receive a first preference for performance or reduced power consumption for a plurality of sets of cores; and
select a core mask for the plurality of sets of cores based on the first preference, a workload type, and at least one of a core utilization or a foreground activity.

2. The apparatus of claim 1, wherein:
the plurality of sets of cores are of different types;
each different type has a different performance and power consumption; and
the core mask indicates a number of active cores for each type of the different types.

3. The apparatus of claim 1, wherein the first preference is selected from among a plurality of preferences which extend in a performance/power consumption spectrum.

4. The apparatus of claim 1, wherein the workload type is determined from among a plurality of workload types comprising bursty, sustained, battery life and idle.

5. The apparatus of claim 1, wherein the first preference is received from an original equipment manufacturer.

6. The apparatus of claim 1, wherein:
the core mask is selected from a table of core masks;
the core masks in the table are cross-referenced to different workload types and to different second preferences;
one of the second preferences is selected based on the first preference and the at least one of the core utilization or the foreground activity; and
the selected core mask is cross-referenced to the one of the second preferences and the workload type.

7. The apparatus of claim 6, wherein the second preferences extend in a performance/power consumption spectrum.

8. The apparatus of claim 6, wherein the second preferences correspond to different core masks with different numbers of active cores, for at least one of the different workload types.

9. The apparatus of claim 6, wherein:
the plurality of sets of cores are of different types;
each different type has a different performance; and
when the workload type is bursty, the different second preferences correspond to different core masks with different numbers of active cores, for a highest performance core type of the different types.

10. An apparatus, comprising:
a plurality of sets of cores, wherein each set is of a different type, and each different type has a different performance and power consumption;
a driver to indicate a preference for performance or reduced power consumption for the plurality of sets of cores, wherein the preference is based on an original equipment manufacturer setting and at least one of a core utilization or a foreground activity; and
firmware to provide core parking hints to an operating system scheduler in response to the preference.

11. The apparatus of claim 10, wherein the original equipment manufacturer setting is selected from among a plurality of settings which extend in a performance/power consumption spectrum.

12. The apparatus of claim 10, wherein the core parking hints comprise a selected core mask which is based on the preference and a workload type of the apparatus.

13. The apparatus of claim 12, wherein the firmware comprises a table of core masks and the selected core mask is selected from the table based on the preference and a workload type of the apparatus.

14. The apparatus of claim 13, wherein the workload type is determined from among a plurality of workload types comprising bursty, sustained, battery life and idle.

15. A non-transitory, computer-readable medium comprising instructions that, when executed by one or more processors, cause the one or more processors to:
obtain a first preference for high performance or low power consumption for a plurality of sets of cores, wherein the first preference is selected from among a plurality of preferences which extend in a performance/power consumption spectrum;
determine a second preference based on the first preference and at least one of a core utilization or a foreground activity; and
read a table to determine a core mask which is cross-referenced to the second preference and a workload type.

16. The non-transitory, computer-readable medium of claim 15, wherein the second preference is biased toward a relatively high performance when the at least one of a core utilization or a foreground activity is relatively high.

17. The non-transitory, computer-readable medium of claim 15, wherein the core mask provides core parking hints to an operating system scheduler.

18. The non-transitory, computer-readable medium of claim 15, wherein the first preference is received from an original equipment manufacturer.

19. The non-transitory, computer-readable medium of claim 15, wherein the one or more processors comprise the plurality of sets of cores, and the core mask indicates a number of active cores for each set of cores of the plurality of sets of cores.

20. The non-transitory, computer-readable medium of claim 19, wherein performance and power consumption are different for each set of cores of the plurality of sets of cores.
